(19) United States
(12) Patent Application Publication
(10) Pub. No.: US 2015/0017968 A1
(43) Pub. Date: Jan. 15, 2015

(54) METHOD AND APPARATUS FOR COMMUNICATING INFORMATION REGARDING MULTIPLE SUBSCRIPTIONS

(71) Applicants: Jorma Johannes Kaikkonen, Oulu (FI); Jussi-Pekka Koskinen, Oulu (FI); Jarkko Tuomo Koskela, Oulu (FI); Petri Juhani Vasenkari, Turku (FI); Hannu Ilmari Pirilä, Littoinen (FI); Sari Kaarina Nielsen, Espoo (FI)

(72) Inventors: Jorma Johannes Kaikkonen, Oulu (FI); Jussi-Pekka Koskinen, Oulu (FI); Jarkko Tuomo Koskela, Oulu (FI); Petri Juhani Vasenkari, Turku (FI); Hannu Ilmari Pirilä, Littoinen (FI); Sari Kaarina Nielsen, Espoo (FI)

(73) Assignee: Nokia Corporation, Espoo (FI)

(21) Appl. No.: 14/377,113

(22) PCT Filed: Feb. 23, 2012
(86) PCT No.: PCT/IB2012/050841

§ 371 Date: Aug. 6, 2014

(51) Int. Cl. H04W 8/18

(52) U.S. Cl. CPC H04W 8/18
USPC 455/418

(57) ABSTRACT

A method, apparatus and computer program product are provided in which the network is informed of a device supporting multiple subscriptions as well as other information related to the operation of the mobile terminal having the multiple subscriptions. In this regard, a network entity is caused to be informed that a mobile terminal supports a plurality of subscriptions. The method may also cause information regarding the networks capable of being monitored by the mobile terminal to be provided to the network entity.

### TECHNOLOGICAL FIELD

An example embodiment of the present invention relates generally to a device supporting multiple subscriptions and, more particularly, the communication of information regarding the plurality of subscriptions.

### BACKGROUND

There is an increasing demand for devices that can support multiple subscriptions, thereby supporting simultaneous wireless, e.g., cellular, access with different networks, such as different public land mobile networks (PLMNs) and/or networks operated by different carriers and/or different network operators. In order to support multiple subscriptions, devices, such as mobile terminals, may include multiple SIMs. In this regard, devices that include two SIMS are often referred to as dual SIM devices. However, devices may include any number of SIMs for supporting three, four, five or more subscriptions.

Dual SIM devices may permit consumer to reduce their call tariffs. In this regard, by utilizing the SIMs from two different operators on the same dual SIM device, the user is able to select the less expensive network for establishing an active connection. There are two principle types of dual SIM devices, namely, dual SIM dual standby (DSDS) devices and dual SIM dual active (DSDA) devices. DSDA devices may be utilized by users who desire to separate different contact groups. In this regard, a user of a DSDA device may provide one phone number associated with a first SIM to their business contacts and a different phone number associated with a second SIM to their private contacts since a DSDA device is able to receive a call to both SIMs regardless of other active connections.

In contrast to a DSDA device that permits the user to receive a call to both SIMs regardless of other active connections, a DSDS device having multiple subscriptions may allow all subscriptions to be registered to a wireless network, such as a cellular or other radio access network, but only one subscription can set up an active radio link toward the network at a time. In other words, a DSDS device generally has a single radio front end and base band chain. There are various subcategories of DSDS devices depending upon the status of the connection that another subscription can have toward the network while one subscription has an active connection toward the network. These subcategories range from DSDS devices in which a user manually selects the subscription that is to be active and registered to the network to DSDS devices in which the DSDS device interrupts an active packet switched connection, e.g., a data call, of one subscription in order to momentarily listen for pages in accordance with the other subscription.

In order to overcome some of the limitations of DSDS devices that have only a single radio front end and base band chain, a DSDS device may include multiple, such as two, standalone cellular radios with each SIM connected to a respective cellular radio. In this context, a cellular radio may include the base band chain and the radio frequency hardware, as well as the software that controls the radio frequency hardware.

In an instance in which a DSDS device interrupts an active connection with a first network in order to read paging information from another network or to perform other procedures such as to perform tracking area updates or cell search procedures, a gap may be introduced into the active connection with the first network which may, in turn, negatively impact the communications conducted with the first network. For example, the gap in the reception from the first network may prevent the mobile terminal from promptly acknowledging and/or negatively acknowledging signals received from the first network, thereby preventing network downlink adaptation from functioning properly. Additionally, if the gaps introduced into the reception from the first network prevent the mobile terminal from transmitting signals in the manner requested or allocated by the network, network uplink adaptation may also not function promptly. Additionally, the gaps introduced by the reception from the first network may result in missed paging which may, in turn, cause the network to page the mobile terminal within a larger area, thereby increasing the paging load for several cells. Still further, the gap introduced in the reception from the first network may even cause the connection with the first network to be released.

In the idle state in certain networks, such as a universal mobile telecommunications system (UMTS) terrestrial radio access network (UTRAN) or a global system for mobile communications (GSM)/Edge radio access network (GERAN), a mobile terminal may be allowed to interrupt the paging reception from the serving cell while reading system information for cell-reselection purposes. The carriers and radio access technology which should be evaluated by the mobile terminal for reselection purposes are signaled by the network. As such, an interruption in the paging reception as introduced by a DSDS device in order to read the system information of another network may also violate the current requirement specifications in an instance in which the other network has not been configured by the serving cell.

It may be difficult to predict the manner in which a network will interpret the gaps in reception introduced by a DSDS device in order to read paging occasions or system information of another network. However, the first network may interpret shorter gaps, such as gaps of tens of milliseconds, as a radio problem, while longer gaps may be classified as an error. As a result, the control algorithms, such as the algorithms for link adaptation, power control or the like, that are implemented by the network may be inaccurate. In other instances, there may be radio link failure and the initiation of corresponding recovery mechanisms. The challenges created by the gaps created in the reception from the first network by a DSDS device that reads paging occasions or system information from another network may not only impact the DSDS device, but may also negatively impact other mobile terminals supported by the same cell since the cell may experience decreased performance as a result of the network resources being consumed by the DSDS device. Additionally, the adaptation algorithms that are intended to optimize the network performance may also be inaccurate as a result of the gaps introduced to the reception from the first network by the DSDS device which may impact network performance and, in turn, the performance of other mobile terminals.

### BRIEF SUMMARY

A method, apparatus and computer program product are provided according to one embodiment of the present invention in which the network is informed of a device supporting multiple subscriptions. In one embodiment, the method, apparatus and computer program product may also inform the network of other information related to the operation of the mobile terminal having the multiple subscriptions. By informing the network of the mobile terminal having the multiple subscriptions, the network and the mobile terminal may subsequently communicate in an improved fashion as well as in a manner that reduces the impact upon the network and other mobile terminals.

In one embodiment, a method is provided that includes causing a network entity to be informed that a mobile terminal supports a plurality of subscriptions. The method of this embodiment also causes information regarding the networks capable of being monitored by the mobile terminal to be provided to the network entity.

In another embodiment, an apparatus is provided that includes at least one processor and at least one memory storing computer program code with the at least one memory and the computer program code configured to, with the processor, cause the apparatus to cause a network entity to be informed that a mobile terminal supports a plurality of subscriptions. The at least one memory and the computer program code are also configured to, with the processor, cause the apparatus of this embodiment to cause information regarding the networks capable of being monitored by the mobile terminal to be provided to the network entity.

In a further embodiment, a computer program product is provided that includes at least one computer-readable storage medium having computer-executable program code portions stored therein with the computer-executable program code portions including program instructions configured to cause a network entity to be informed that a mobile terminal supports a plurality of subscriptions. The computer-executable program code portions of this embodiment also include program instructions configured to cause information regarding the networks capable of being monitored by the mobile terminal to be provided to the network entity.

In yet another embodiment, an apparatus is provided that includes means for causing a network entity to be informed that a mobile terminal supports a plurality of subscriptions. The apparatus of this embodiment also includes means for causing information regarding the networks capable of being monitored by the mobile terminal to be provided to the network entity.

In one embodiment, a method is provided that includes receiving an indication from a mobile terminal that the mobile terminal supports a plurality of subscriptions. The method of this embodiment also receives information regarding the networks capable of being monitored by the mobile terminal.

In another embodiment, an apparatus is provided that includes at least one processor and at least one memory storing computer program code with the at least one memory and the computer program code configured to, with the processor, cause the apparatus to receive an indication from a mobile terminal that the mobile terminal supports a plurality of subscriptions. The at least one memory and the computer program code are also configured to, with the processor, cause the apparatus of this embodiment to receive information regarding the networks capable of being monitored by the mobile terminal.

In a further embodiment, a computer program product is provided that includes at least one computer-readable storage medium having computer-executable program code portions stored therein with the computer-executable program code portions including program instructions configured to receive an indication from a mobile terminal that the mobile terminal supports a plurality of subscriptions. The computer-executable program code portions of this embodiment also include program instructions configured to receive information regarding the networks to be monitored by the mobile terminal.

In yet another embodiment, an apparatus is provided that includes means for receiving an indication from a mobile terminal that the mobile terminal supports a plurality of subscriptions. The apparatus of this embodiment also includes means for receiving information regarding the networks capable of being monitored by the mobile terminal.

### BRIEF DESCRIPTION OF THE DRAWINGS

Having thus described certain example embodiments of the present invention in general terms, reference will hereinafter be made to the accompanying drawings, which are not necessarily drawn to scale, and wherein:

FIG. 1 is a schematic representation of a system in which a mobile terminal having multiple SIMs may communicate with a plurality of networks in accordance with an example embodiment of the present invention;

FIG. 2 is a block diagram of an apparatus from the perspective of a mobile terminal that may be specifically configured to perform the operations of an example embodiment of the present invention;

FIG. 3 is a block diagram of an apparatus from the perspective of a network entity, such as an access point, that may be specifically configured to perform the operations of an example embodiment of the present invention;

FIG. 4 is a flow chart illustrating the operations performed from the perspective of a mobile terminal in accordance with one embodiment of the present invention; and

FIG. 5 is a flow chart illustrating the operations performed from the perspective of a network entity, such as an access point, in accordance with one embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

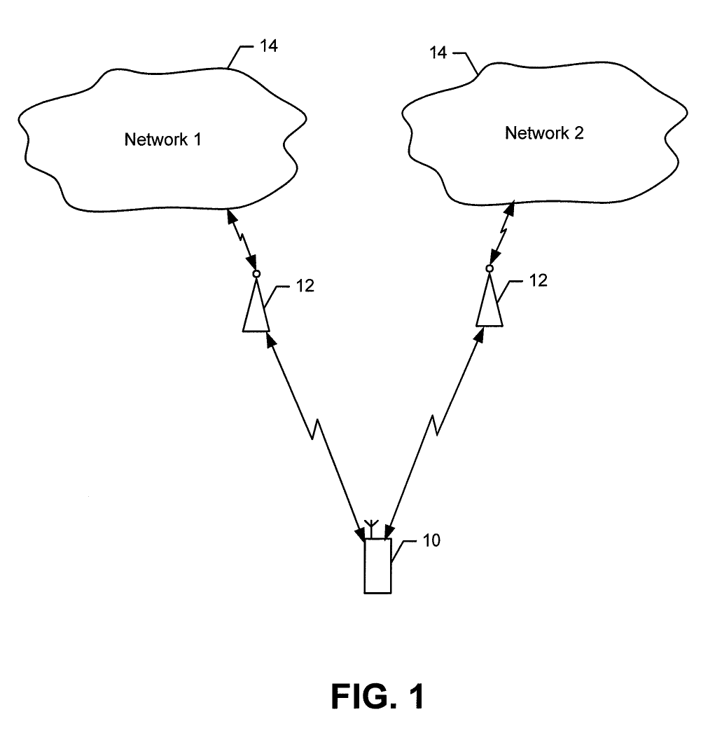

Referring now to FIG. 1, a system for supporting a mobile terminal 10 having a plurality of subscriptions. The mobile terminals may be of various types of mobile communication devices such as, for example, mobile telephones, PDAs, pagers, laptop computers, or any of numerous other hand held or portable communication devices, computation devices, content generation devices, content consumption devices, or combinations thereof. The plurality of subscriptions may permit the mobile terminal to communicate via an access point 12, such as an Node B, an evolved Node B (eNB), a base station or the like, with a plurality of networks 12 designated Network 1 and Network 2, for example, in FIG. 1. The mobile terminal may communicate with various types of networks including, for example, a Long Term Evolution (LTE) network, an LTE-Advanced (LTE-A) network, a Global Systems for Mobile communications (GSM) network, a Code Division Multiple Access (CDMA) network, e.g., a Wideband CDMA (WCDMA) network, a CDMA2000 network or the like, a General Packet Radio Service (GPRS) network, a UTRAN, a GERAN or other type of network.

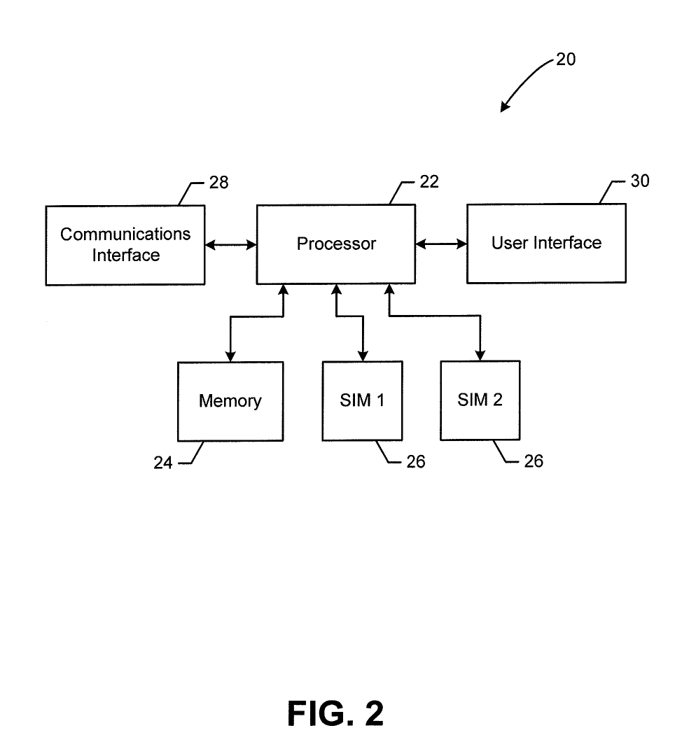

Referring now to FIG. 2, an apparatus 20 that may be embodied by or otherwise associated with a mobile terminal 10 for informing a network 14 of its multiple subscriptions may include or otherwise be in communication with a processor 22, a memory device 24, a communication interface 28, a user interface 30 and a circuit card or other secure module or other type of secure memory for storing a plurality of SIMs 26. A SIM, such as a code division multiple access (CDMA) SIM (CSIM), a Universal SIM (USIM), an internet protocol (IP) multimedia subsystem (IMS) SIM (ISIMs), a removable user identify module (RUIM) or the like, may store the network access application (NAA) that includes the cryptographic credentials that allows use of at least some of the services of a communication service provider. The NAA may be stored on a removable module or a non-removable module, e.g., a surface mounted or embedded chip.

In some example embodiments, the processor 22 (and/or co-processors or any other processing circuitry assisting or otherwise associated with the processor) may be in communication with the memory device 24 via a bus for passing information among components of the apparatus 20. The memory device may include, for example, one or more non-transitory volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The apparatus 20 may, in some embodiments, be embodied by a mobile terminal 10. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading. In the embodiment in which the apparatus 20 is embodied as a mobile terminal 10, the processor may be embodied by the processor of the mobile terminal.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a mobile terminal 10) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

Meanwhile, the communication interface 26 may be any means such as a device or circuitry embodied in either hardware or a combination of hardware and software that is configured to receive and/or transmit data from/to a network 12 and/or any other device or module in communication with the apparatus 20. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In order to support multiple active connections simultaneously, such as in conjunction with a DSDA device, the communications interface of one embodiment may include a plurality of cellular radios, such as a plurality of radio front ends and a plurality of base band chains. In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some example embodiments, such as instances in which the apparatus 20 is embodied by a mobile terminal 10, the apparatus may include a user interface 28 that may, in turn, be in communication with the processor 22 to receive an indication of a user input and/or to cause provision of an audible, visual, mechanical or other output to the user. As such, the user interface may include, for example, a keyboard, a mouse, a joystick, a display, a touch screen(s), touch areas, soft keys, a microphone, a speaker, or other input/output mechanisms. Alternatively or additionally, the processor may comprise user interface circuitry configured to control at least some functions of one or more user interface elements such as, for example, a speaker, ringer, microphone, display, and/or the like. The processor and/or user interface circuitry comprising the processor may be configured to control one or more functions of one or more user interface elements through computer program instructions (e.g., software and/or firmware) stored on a memory accessible to the processor (e.g., memory device and/or the like).

Further, the circuit card or other secure module or other type of secure memory may be configured to store one or more SIMs 26, as described below. The SIMs may be software SIMs of various types including, for example, CSIMs, USIMs, RUIMs and ISIMs. In one example embodiment, the circuit card is embodied by a universal integrated circuit card (UICC), an embedded UICC (eUICC) or the like in order to store the SIMs to facilitate identification and authentication of the user of the mobile terminal 10. In this regard, a SIM may include a unique serial number (ICCID) or other permanent identifier, an international mobile subscriber identity (IMSI), security authentication and ciphering information, temporary information related to the local network, a list of the services to which the user has access and/or passwords.

The apparatus 20 may include one or more SIMs 26, each of which supports one or more of the subscriptions maintained by the apparatus. In the illustrated embodiment, the apparatus includes a pair of SIMs, designated SIM 1 and SIM 2, such that the apparatus may be embodied by a dual SIM device, such as a DSDA or a DSDA. However, the apparatus may include three or more SIMs, such that the apparatus is embodied by a multiSIM device.

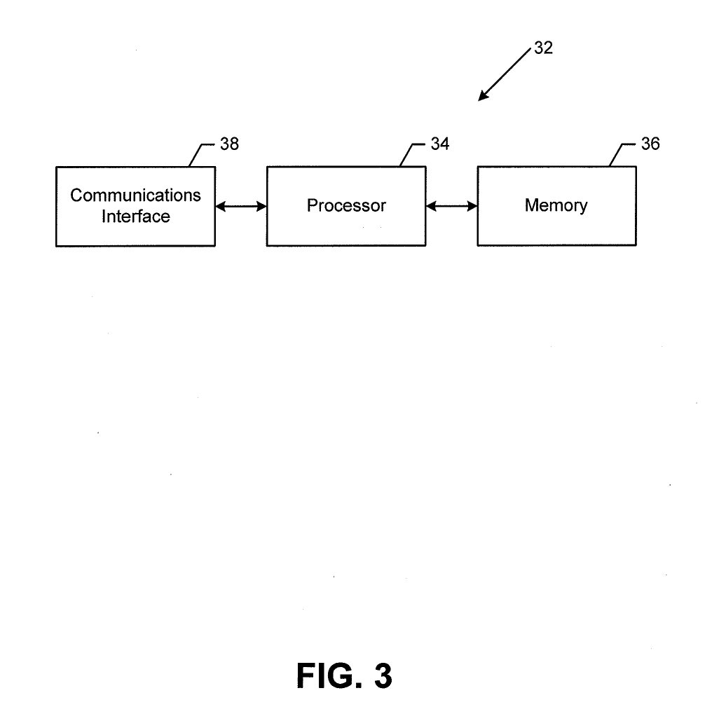

Referring now to FIG. 3, an apparatus 32 that may be embodied by or otherwise associated with a network entity, such as an access point 12, for communicating with a mobile terminal 10 regarding the multiple SIMs 26 supported by the mobile terminal may include or otherwise be in communication with a processor 34, a memory device 36 and a communication interface 38. In some example embodiments, the processor (and/or co-processors or any other processing circuitry assisting or otherwise associated with the processor) may be in communication with the memory device via a bus for passing information among components of the apparatus. The memory device may include, for example, one or more non-transitory volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The apparatus 32 may, in some example embodiments, be embodied by a network entity, such as an access point 12 or other computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 34 may be embodied in a number of different ways. For example, the processor may be embodied as one or more of various hardware processing means such as a coprocessor, a microprocessor, a controller, a DSP, a processing element with or without an accompanying DSP, or various other processing circuitry including integrated circuits such as, for example, an ASIC, an FPGA, a MCU, a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading. In the embodiment in which the apparatus 32 is embodied as a network entity, the processor may be embodied by the processor of the network entity, such as the processor of a server or other computing device.

In an example embodiment, the processor 34 may be configured to execute instructions stored in the memory device 36 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a network entity 14) configured to employ an embodiment of the present invention by further configuration of the processor by instructions for performing the algorithms and/or operations described herein. The processor may include, among other things, a clock, an ALU and logic gates configured to support operation of the processor.

Meanwhile, the communication interface 38 may be any means such as a device or circuitry embodied in either hardware or a combination of hardware and software that is configured to receive and/or transmit data from/to a network 14 and/or any other device or module in communication with the apparatus 32. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, DSL, USB or other mechanisms.

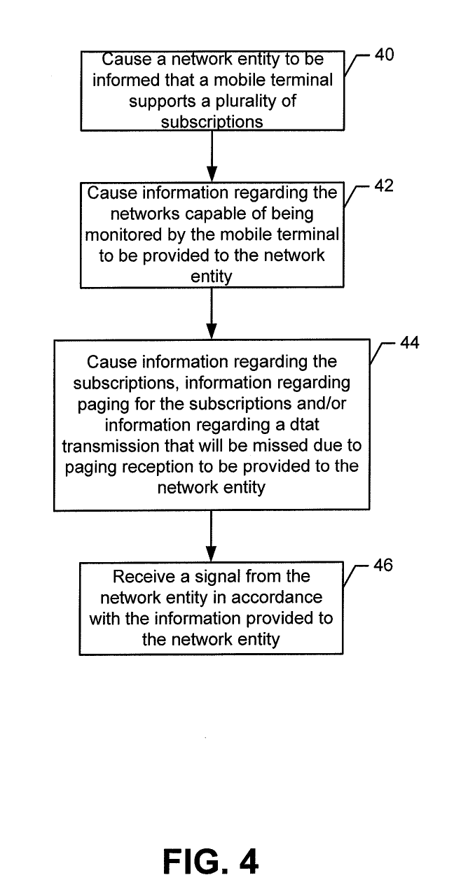

Referring now to FIG. 4, the operations performed by an apparatus 20 embodied by a mobile terminal 10 are illustrated. As described above in conjunction with FIG. 2, an apparatus embodied by a mobile terminal may include means, such as the processor 22, the communications interface 28 or the like, for causing a network entity, such as an access point 12, to be informed that the mobile terminal supports a plurality of subscriptions. See operation 40 of FIG. 4. In order the support the plurality of subscriptions, the mobile terminal may include a plurality of SIMs, each of which supports one or more subscriptions, or a single SIM that supports each of the plurality of subscriptions. As shown in operation 42 of FIG. 4, the apparatus embodied by the mobile terminal may include means, such as the processor, the communication interface or the like, for causing information regarding aspects of the operation of the mobile terminal that are altered by its support of multiple subscriptions including information regarding the networks capable of being monitored by the mobile terminal. In one embodiment, the apparatus, such as the processor, the communication interface or the like, may be configured to inform the network entity that the mobile terminal supports a plurality of subscriptions and to provide other information related to the operation of the mobile terminal during registration of the mobile terminal with the network 14, such as by including the information within the mobile terminal capability information that is provided to the network upon registration. See operation 44 of FIG. 4.

The information that is provided by the apparatus 20 to the network entity may include information regarding the state of the subscriptions. For example, the apparatus, such as the processor 22, the communication interface 28 or the like, may cause information to be provided that identifies one or more of the subscriptions to be attached, e.g., registered. In one embodiment, the apparatus may also include means, such as the processor, the communication interface or the like, for maintaining an active connection, such as a data or voice connection, with the network 14 utilizing a respective subscription. In another embodiment, the apparatus may also include means, such as the processor, the communication interface or the like, for listening for a page or some other type of non-data transmission from the network utilizing, for example, a respective subscription. The subscriptions need not be attached, however, and the apparatus, such as the processor, the communication interface or the like, may cause information to be provided that identifies one or more subscriptions to not be attached, e.g., not registered.

The information that is provided by the apparatus 20 to the network entity may include information regarding the subscriptions, such as the number of subscriptions and/or the type of subscriptions. For example, the apparatus, such as the processor 22, the communication interface 28 or the like, may cause information to be provided that identifies whether a subscription is active and/or attached. The apparatus, such as the processor, the communication interface or the like, may also or alternatively cause information to be provided that identifies the networks, such as the public land mobile networks (PLMN), and/or operators with which the respective subscriptions are associated.

The information that is provided by the apparatus 20 to the network entity may include information regarding paging for the subscriptions. In this regard, the apparatus, such as the processor 22, the communication interface 28 or the like, may cause information to be provided that identifies paging occasions that will be missed. For example, the information regarding the paging occasions that will be missed may include information regarding the percent of paging occasions that will be missed, information identifying the paging occasions that will be missed, information regarding the probability of missing the paging occasions and/or information regarding the mobile terminal missing part of a combined paging occasion. In this regard, a combined paging occasion refers to a situation in which a mobile terminal receives multiple page messages and combines those page messages, such as within the receiver of the mobile terminal, in order to decode the paging occasion.

The apparatus 20, such as the processor 22 or the like, may determine the probability of missing the paging occasions in various manners. In regards to asynchronous systems and/or in systems in which the radio frame lengths are not equal, the instances in which paging occasions may overlap between two radio access technologies (RATs) and/or two carriers may be a function of the individual cells' timing and the radio frame cycle. Also, the paging cycle may be different between the RATs. Thus, the apparatus, such as the processor or the like, may determine those instances in which the paging occasions would overlap in time based on the time differences between the RATs and the paging cycle of each individual RAT, thereby permitting the apparatus, such as the processor or the like, to determine the probability that a single page for a RAT may be missed. In other instances, the apparatus, such as the processor or the like, may determine the probability of missing a paging occasion based upon a more general estimation. In this regard, for example, mobile terminals, such as mobile terminals in an Idle mode, may autonomously change cells without providing signaling to the network, such as in instances in which the cells belong to the same traffic area. Thus, the occasions in which the paging occasions will overlap may correspondingly change frequently in this embodiment without information being exchanged between the mobile terminal and the network 14. Thus, the apparatus, such as the processor or the like, may provide a general probability of missing a paging occasion so as to avoid the extensive signaling otherwise required to indicate the specific occasions in which an overlap between paging occasions would occur. Similarly, the apparatus, such as the processor or the like, may provide a general probability of missing a paging occasion in an instance in which the radio or system frame length/cycles are different since the pattern may become quite long and/or complicated.

The information regarding paging for the subscriptions may also include the time positions or occasions during which the mobile terminal needs to receive paging for the respective subscriptions. Additionally or alternatively, the information regarding paging for the subscriptions may also include the paging group via which the mobile terminal needs to receive paging for the respective subscriptions.

The information that is provided by the apparatus 20 to the network entity may include information regarding prioritization of paging for the respective subscriptions. In this regard, a paging collision between pages for different subscriptions may be resolved based upon the prioritization with the page for the subscription having the greatest prioritization being received and the page for the subscription having a lower prioritization being missed.

The information that is provided by the apparatus 20 to the network entity may also or alternatively include information regarding a data transmission that will be missed due to paging reception. In this regard, the data transmission may be either an uplink transmission or a downlink transmission. The information that is provided regarding a data transmission that may be missed may be of the same type that may be provided in regards to missing a paging occasion. For example, the information that is provided regarding a data transmission that may be missed may include information regarding the percent or probability of missing a data transmission and/or information identifying the data transmission that may be missed.

In one embodiment, the apparatus 20, such as the processor 22, the communication interface 28 or the like, may cause information to be provided regarding the SIMs 26, each of which may support one or more of the subscriptions. The information that is provided by the apparatus 20 to the network entity regarding the SIMs 26 may include the number of SIMs, e.g., two, three or more SIMs, as well as the type of device that embodies or is otherwise associated with the apparatus, such as a DSDA device or a DSDS device.

The apparatus 20 of one embodiment may also include means, such as the processor 22, the communications interface 28 or the like, for causing the network entity to be informed of its capabilities. For example, the apparatus, such as the processor or the communications interface, may cause the network entity to be informed of the maximum power limitation that is needed, such as when each of a plurality of transmitters associated with the plurality of subscriptions are concurrently transmitting. As another example, the apparatus, such as the processor or the communications interface, may cause the network entity to be informed of restrictions related to the supported networks.

After the network entity has been informed that the mobile terminal 10 has multiple SIMs 26 and been provided with other information regarding the operation or performance of the mobile terminal, the apparatus 20 may include means, such as the processor 22, the communications interface 28 or the like, for receiving a signal from the network entity in accordance with the information provided to the network entity. See operation 46 of FIG. 4. As described below in conjunction with the operations performed by the network entity, the signal may be provided to the mobile terminal in such a manner as to take into account the multiple subscriptions in order to reduce the negative impact that may otherwise be created as a result of the multiple subscriptions.

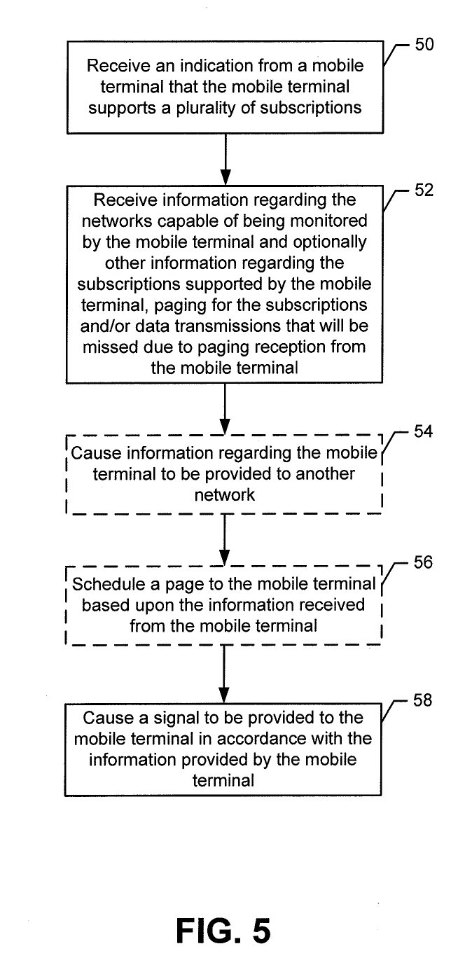

Referring now to FIG. 5, the operations performed by an apparatus 32 embodied by or otherwise associated with a network entity, such as an access point 12, are illustrated. As described above in conjunction with FIG. 3, an apparatus embodied by a network entity may include means, such as the processor 34, the communications interface 38 or the like, for receiving an indication from the mobile terminal 10 that the mobile terminal supports a plurality of subscriptions. See operation 50 of FIG. 5. As shown in operation 52, the apparatus embodied by the network entity may also include means, such as the processor, the communication interface or the like, for receiving information regarding networks that are capable of being monitored by the mobile terminal. As described above, the apparatus, such as the processor, the communication interface or the like, may also be configured to receive the information regarding the subscriptions, information regarding paging for the subscriptions, information regarding a data transmission that will be missed due to paging reception, information regarding a plurality of SIMs that support the subscriptions as well as the other related information during registration of the mobile terminal with the network 14, such as part of the mobile terminal capability information that is provided to the network upon registration.

As shown in operation 58 of FIG. 5, the apparatus 32 embodied by or otherwise associated with a network entity may also include means, such as the processor 34, the communications interface 38 or the like, for causing a signal to be provided to the mobile terminal 10 in accordance with the information provided by the mobile terminal. In this regard, the apparatus, such as the processor, embodied by the network entity may take into account the performance of the mobile terminal attributable to its support of the multiple subscriptions and may provide signals to the mobile terminal in such a manner and with such timing that the mobile terminal is more likely to receive the signals, thereby reducing some of the negative impact that is created by the support by a mobile terminal of multiple subscriptions.

By way of example and as shown in operation 56 of FIG. 5, the apparatus 32 embodied by or otherwise associated with a network entity may include means, such as the processor 34 or the like, for scheduling a page to the mobile terminal 10 based upon the information provided by the mobile terminal, such as the information regarding the networks 14 capable of being monitored by the mobile terminal. In this regard, based upon the information provided by the mobile terminal, the apparatus, such as the processor, embodied by the network entity may schedule pages during a time period that is different than the paging occasions for the other networks, thereby increasing the likelihood that the mobile terminal will receive the page. Additionally or alternatively, the apparatus, such as the processor, embodied by the network entity may schedule the pages in accordance with a different or altered paging pattern, such as by providing pages more or less frequently, based upon paging occasions of the other networks and/or the probability that the mobile terminal will otherwise miss a page, in order to increase the likelihood that the mobile terminal will receive the page.

Additionally or alternatively, the apparatus 32, such as the processor 34, embodied by a network entity may modify the network adaptation algorithms, such as the uplink and/or downlink adaptation algorithms, based upon the information provided by the mobile terminal 10 related to the multiple subscriptions. By modifying the network adaptation algorithms to take into account the behavior of the mobile terminal that is required to support the multiple subscriptions, the apparatus embodied by the network entity may monitor the network performance of the mobile terminal on a more accurate basis and avoid unnecessary changes, such as unnecessary adaptation of the uplink and/or the downlink.

The apparatus 32, such as the processor 34, embodied by a network entity may additionally or alternatively receive and consider the information provided by the mobile terminal 10 regarding the networks that the mobile terminal is capable of monitoring and/or information regarding its capabilities, such as the maximum power limitation, restrictions related to supported RATs, etc. Based upon the information provided by the mobile terminal related to its capabilities, the apparatus, such as the processor, embodied by the network entity may communicate with the mobile terminal in a manner that takes into account the capabilities of the mobile terminal, thereby increasing the likelihood of successful communications.

As shown in operation 54 of FIG. 5, the apparatus 32 embodied or otherwise associated with a network entity may include means, such as the processor 34, the communications interface 38 or the like, for causing information regarding the mobile terminal 10 to be provided to another network 14, such as another network with which the mobile terminal communicates via another one of the subscriptions. By way of example, the networks associated with the subscriptions of a mobile terminal could coordinate with one another in an instance in which the mobile terminal is in the active mode, that is, when the mobile terminal has established a connection. In this regard, the networks could coordinate communications with the mobile terminal so as to avoid contention and to increase the likelihood of successful communication with the mobile terminal. As another example, the apparatus embodied by a network entity could share information regarding the paging group, e.g., information regarding the paging occasions, of the mobile terminal with the other networks associated with the other subscriptions of the mobile terminal so that the networks could take the paging occasions into account when communicating with the mobile terminal, such as by scheduling communications with the mobile terminal at different times than the paging occasions. As yet another example, the apparatus embodied by the network entity could advise the other networks associated with the other subscriptions of the mobile terminal when the active connection supported by the network entity with the mobile terminal has been released in order to facilitate communication with the mobile terminal by the other networks.

As described above, FIGS. 4 and 5 illustrate a flowchart of an apparatus, method, and computer program product from the perspective of a mobile terminal 10 and a network entity, respectively, according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a non-transitory memory device of an apparatus employing an embodiment of the present invention and executed by a processor of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a non-transitory computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as shown by the dashed boxes in FIGS. 4 and 5. Modifications, additions, or amplifications to the operations above may be performed in any order and in any combination.

As described above, a method, apparatus and computer program product are provided so as to inform a network of a device, such as a mobile terminal 10, having multiple subscriptions and to provide other information related to the networks that are capable of being monitored by the mobile terminal. By informing the network of the device having the multiple subscriptions, the network and the device may subsequently communicate in an improved fashion as well as in a manner that reduces the impact upon the network and other mobile terminals that is otherwise occasioned by the mobile terminal's support of the multiple subscriptions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-46. (canceled)

47. A method comprising:
causing, with a processor, a network entity to be informed that a mobile terminal supports a plurality of subscriptions; and
causing, with the processor, information regarding networks capable of being monitored by the mobile terminal to be provided to the network entity.

48. A method according to claim 47 wherein one or more of the subscriptions are attached, and wherein the method further comprises causing an active connection to be maintained.

49. A method according to claim 47 wherein one or more of the subscriptions are attached, and wherein the method further comprises listening for a page without establishment of an active connection.

50. A method according to claim 47 wherein the plurality of subscriptions are not attached.

51. A method according to claim 47 further comprising causing information regarding the subscriptions to be provided to the network entity.

52. A method according to claim 51 wherein the information regarding the subscriptions comprises at least one of information regarding whether a subscription is active or information regarding whether a subscription is attached.

53. A method according to claim 47 further comprising causing information regarding paging for the subscriptions to be provided to the network entity.

54. A method according to claim 47 further comprising causing information regarding a data transmission that will be missed due to paging reception to be provided to the network entity.

55. An apparatus comprising at least one processor and at least one memory storing computer program code, the at least one memory and the computer program code configured to, with the processor, cause the apparatus to at least:
cause a network entity to be informed that the apparatus supports a plurality of subscriptions; and
cause information regarding networks capable of being monitored by the apparatus to be provided to the network entity.

56. An apparatus according to claim 55 wherein one or more of the subscriptions are attached, and wherein the at least one memory and the computer program code are further configured to, with the processor, cause the apparatus to cause an active connection to be maintained.

57. An apparatus according to claim 55 wherein one or more of the subscriptions are attached, and wherein the at least one memory and the computer program code are further configured to, with the processor, cause the apparatus to listen for a page without establishment of an active connection.

58. An apparatus according to claim 55 wherein the plurality of subscriptions are not attached.

59. An apparatus according to claim 55 wherein the at least one memory and the computer program code are further configured to, with the processor, cause the apparatus to cause information regarding the subscriptions to be provided to the network entity.

60. An apparatus according to claim 55 wherein the at least one memory and the computer program code are further configured to, with the processor, cause the apparatus to cause information regarding paging for the subscriptions to be provided to the network entity.

61. An apparatus comprising at least one processor and at least one memory storing computer program code, the at least one memory and the computer program code configured to, with the processor, cause the apparatus to at least:
receive an indication from a mobile terminal that the mobile terminal supports a plurality of subscriptions; and
receive information regarding networks capable of being monitored by the mobile terminal.

62. An apparatus according to claim 61 wherein the at least one memory and the computer program code are also configured to, with the processor, cause the apparatus to cause information regarding the mobile terminal to be provided to another network.

63. An apparatus according to claim 61 wherein the at least one memory and the computer program code are also configured to, with the processor, cause the apparatus to receive information regarding the subscriptions from the mobile terminal.

64. An apparatus according to claim 63 wherein the information regarding the subscriptions comprises at least one of information regarding whether a subscription is active or information regarding whether a subscription is attached.

65. An apparatus according to claim 61 wherein the at least one memory and the computer program code are also configured to, with the processor, cause the apparatus to receive information from the mobile terminal regarding paging for the subscriptions.

66. An apparatus according to claim 61 wherein the at least one memory and the computer program code are also configured to, with the processor, cause the apparatus to receive information from the mobile terminal regarding a data transmission that will be missed due to paging reception.
